(19) United States
(12) Patent Application Publication
(10) Pub. No.: US 2008/0222540 A1
(43) Pub. Date: Sep. 11, 2008

(54) Animating thrown data objects in a project environment

(75) Inventors: Egan Schulz, San Jose, CA (US); Andrew Lin, San Francisco, CA (US)

Correspondence Address: HICKMAN PALERMO TRUONG & BECKER LLP/Apple Inc., 2055 GATEWAY PLACE, SUITE 550, SAN JOSE, CA, 95110-1083, US

(73) Assignee: Apple Inc., Cupertino, CA (US)

(21) Appl. No.: 11/714,393

(22) Filed: Mar. 5, 2007

(51) Int. Cl. G06F 3/048

(52) U.S. Cl. 715/764; 715/769

(57) ABSTRACT

Techniques described herein allow user sort data objects in a user interface. The user is able to sort the data objects by throwing them in the user interface. For example, a user imports a collection of data objects into a user interface. The data objects are then displayed graphically in the user interface. The user sorts the data objects by selecting them with an input device and throwing them toward a separate location on screen. The location on screen where the user throws the data objects is called a bucket. A bucket captures data objects thrown in its direction. Once, the data objects have been sorted, the user can use controls to refine the way the data objects are sorted. For example, the user can sort data objects within a bucket, modify the data objects, add additional buckets to the user interface, and perform other similar functions.

### BACKGROUND

Software programs often include features that allow users to display, view, move, and sort items on screen. For example, suppose a user is using a file manager program to display files located in a directory of a computer file system. Within the file manager, the user can view and sort files based on a few pre-determined criteria (e.g., alphabetically, by modification date, etc). In some cases, however, the user may want to sort the files into folders based on their own criteria. Hence, the user may create folders on the computer into which he can place the files. For example, on his computer, the user may create folders such as “Taxes”, “Work”, and “Personal”, “Music”, and “Photos” into which the user can sort documents and files located on the computer. Now, suppose the user has several tax-related documents on their computer. After creating the “Taxes” folder, the user can use their mouse to drag and drop each tax-related document into that folder. Similarly, a “Work” folder may be used to store all work-related documents. Other folders could be created for other categories of files. In each case, the user selects an item with his mouse and drags and drops the item in the appropriate folder.

As another example, suppose a user uses a photo-editing program to sort photographs. Generally, a photo-editing program imports photographs taken by a photographer and displays them on a computer screen. Conventionally, the photo-editing software allows the user to sort the images based on a variety of criteria. For example, the user can sort the images by the date on which they were taken, based on a perceived quality of the photo, based on who was in the photograph, etc. To sort the photographs in the photo-editing program, the photographer has to manually assign an image to a “bucket”. Here, a bucket refers to the location on screen where the image is placed. For example, a bucket in the photo-editing program could be a work project folder for photographs taken in the course of the photographer's work, or a bucket may be a workspace location indicating the perceived quality of an image. But, as with the file manager, the user has to manually pick up each image and drag the image to the bucket where the user believes the photograph should properly be placed.

The process of dragging and dropping items to buckets works fairly well for a small number of items. However, as the number of items grows, the time it takes to manually move each item from its original location to a folder or bucket becomes increasingly greater, and, in the end, wastes a lot of the user's time. Thus, there is a need in the art for techniques that improve the way a user can sort and categorize items on a computer.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

Embodiments of the present invention are illustrated by way of example, and not by way of limitation, in the figures of the accompanying drawings and in which like reference numerals refer to similar elements and in which:

FIG. 1 is a depiction of an example workspace user interface in a photo-editing tool, according to an embodiment of the invention;

FIG. 2 is a depiction of an example workflow for defining workspaces, according to an embodiment of the invention;

FIG. 3 is a depiction of an example workspace user interface for sorting images, according to an embodiment of the invention;

FIG. 4 is a depiction of an example workspace user interface for throwing images into sort buckets, according to an embodiment of the invention;

FIG. 5 is a depiction of an example workspace user interface selecting and refining the images in a sort bucket, according to an embodiment of the invention;

FIG. 6 is a flowchart illustrating an example procedure for animating thrown data objects in a workspace, according to an embodiment of the invention; and

FIG. 7 is a block diagram of a computer system upon which embodiments of the invention may be implemented.

### DETAILED DESCRIPTION

In the following description, for the purposes of explanation, numerous specific details are set forth in order to provide a thorough understanding of embodiments of the present invention. It will be apparent, however, that embodiments of the present invention may be practiced without these specific details. In other instances, well-known structures and devices are shown in block diagram form in order to avoid unnecessarily obscuring embodiments of the present invention.

### Functional Overview

Tools and techniques described herein provide mechanisms which allow data objects to be animated as they are “thrown” in a user interface. As used herein, to “throw” a data object means to select a data object displayed in the user interface using a mouse or other input device and, subsequently, to use the mouse or other input device to cause the data object to move without further user input. In one embodiment, mechanisms may animate the display of such movement of the data object so that it appears that the object was thrown by the user. In one embodiment, the thrown data object is caught and stored in a bucket. In this way, the user can sort data objects into separate buckets with very little wasted motion.

For example, suppose a photo-editing tool includes mechanisms that allow a user to throw images across a screen. After a user imports and displays a set of images in the photo-editing tool, the user may input instructions into the photo-editing tool that cause an image to move across the photo-editing tool's workspace, as if the image was thrown. In one embodiment, the photo-editing tool includes a set of bucket areas into which the images are sorted. A user can sort the images in the photo-editing tool by throwing each image into a particular bucket (e.g., into a bucket for portraits, a bucket for photos with red-eye, etc.).

In one embodiment, the tools and techniques described herein provide mechanisms that animate a thrown data object in a way that simulates the trajectory of a real world object after it has been thrown. For example, the faster the user moves the mouse or other input device, the faster the data object moves away from its original position. In addition, as the data object moves away from its original position, the thrown data object may slow down over time (e.g., as if being acted upon by friction) to further simulate the appearance of a real world object.

Once a data object has been thrown, the tools and techniques described herein provide mechanisms which animate the data object after it has been caught in a bucket. For example, when a thrown data object reaches a bucket, the data object may bounce against the walls of the bucket in a manner similar to how a billiard ball bounces against the sides of a table. In these ways, the tools and techniques described herein visually animate throwing a data object in a user interface.

Additional tools and techniques described herein provide mechanisms which allow a user to create and arrange the buckets the data objects are thrown into.

### Project Environment

The techniques and tools described herein are often described in terms of a project environment. A project environment generally refers to a software application, a user interface, or other tool that allows the user to sort data objects. Sorting, as used herein, can refer to more than just sorting a data object. Sorting may also include viewing, browsing, editing, selecting, placing, moving, categorizing, or manipulating in some fashion a data object.

The techniques and tools described herein are often described in terms of sorting images in a photo-editing tool. This environment is meant to serve as an exemplary environment in which the techniques of the present invention are employed. In alternative implementations, the techniques and tools may be employed in other environments, such as a file manager, multimedia players, a desktop environment, an operating system environment, a Web browsing environment (e.g., an online store, online shopping cart, wish list, etc.), and other environments that allows the user to sort data objects.

According to one embodiment, a project environment may include one or more workspaces, sort buckets, and user interface components in order to facilitate interaction with data objects.

### Data Objects

Data objects include those items thrown by users in a project environment. Data objects generally refer to any type of data structure, object, document, image, graphic, or file accessible to a user in a project environment. In fact, as used herein, data objects are not limited to any particular structure or format. For example, a data object can refer to an image in a photo-editing tool, a document in a file manager application, a database record in a database system, a network object in a network administration program, an image or frame in a Web page design application, a music file in a sound editing program, a data structure in a programming language object, and other types of objects.

### Workspace User Interface

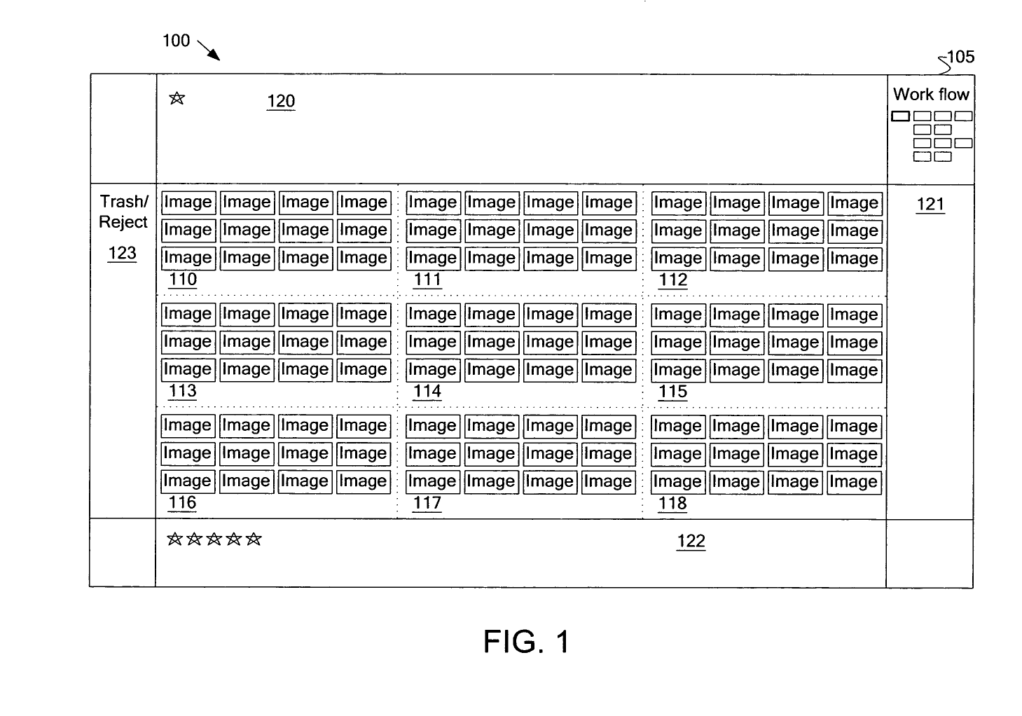

A workspace user interface (“workspace”) generally refers to the portion of a project environment's user interface that displays the collection of data objects. It is the workspace that provides the user interface controls that allow a user to throw a data object from one location on-screen to another. In one embodiment, the user can throw a data object from one workspace to another. In fact, in one embodiment, the user can throw a data object across multiple workspaces and/or from one project environment to another. The workspace can be a desktop, a window within an application, a palette, some other type of user interface control, or a set of user interface controls within a project environment. An example workspace is illustrated in FIG. 1.

Referring to FIG. 1, it depicts example workspace 100 that includes nine grid areas 110-118, a workflow indicator 105, and four sort buckets 120-123. In addition, workspace 100 includes a number of data objects (labeled as images) in each grid area. In one embodiment, a workspace may include a different set of features.

### Grid Areas

A grid area as illustrated in FIG. 1 is an area in a workspace that allows large collections of data objects to be split up into more manageable chunks of data. For example, suppose the data objects displayed into workspace 100 are photographs retrieved from a digital camera's memory card. Often a digital camera's memory card contains hundreds (maybe even thousands) of images. To display that many photographs in one workspace, the images have to be reduced in size. Multiple grid areas allow the user to split the images into smaller, more manageable collections of data.

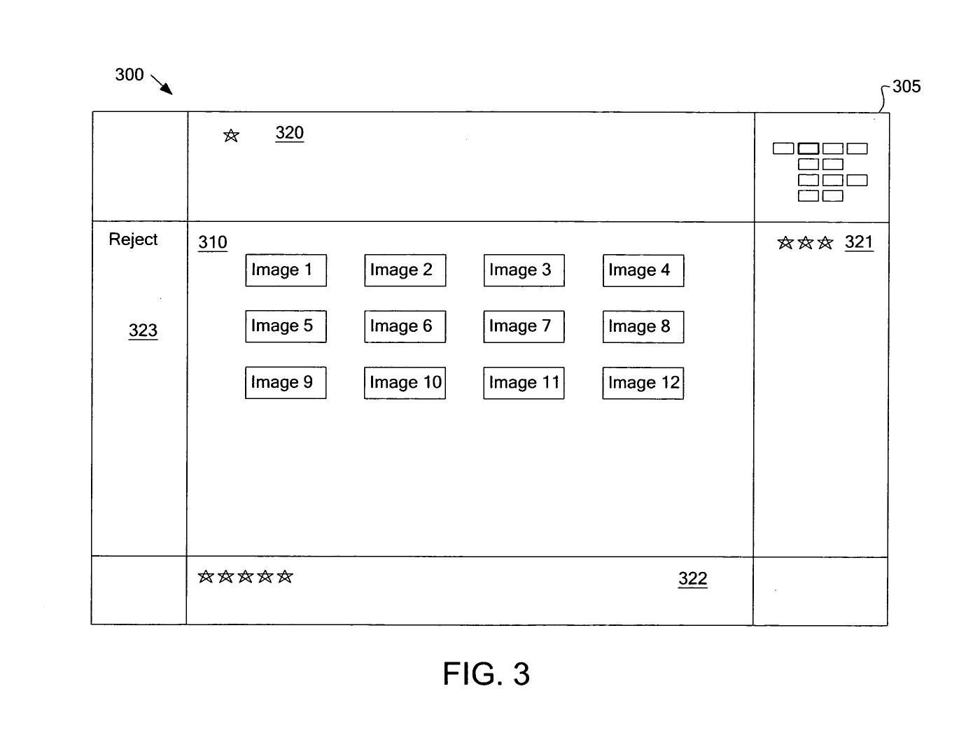

As illustrated in FIG. 1, workspace 100 includes over 100 data objects (e.g., each grid area 110-118 includes 12 data objects). The number of data objects in a grid area can vary based on the total number of data objects in the workspace, the size of the workspace, the size of a grid area, screen resolution, user preference, and other such factors. Splitting the workspace into grid areas allows the user to select a grid area and sort the data objects in that particular grid area. For example, if a user selects grid area 110, then grid area 110 becomes the focus of workspace 100 (e.g., the grid area is expanded, and, possibly, moved to the center of the workspace). In one embodiment, the display size of the data object in grid area 110 is also expanded. According to one embodiment, when grid area 110 becomes the focus, the other grid areas 111-118 and the objects in those grid areas are reduced in size. In one embodiment, grid area 110 is enlarged to fill the entire workspace 100. FIG. 3 illustrates an example of a grid area that has been enlarged to fill the entire workspace.

A workspace does not necessarily need to include grid areas. In many cases, data objects may be displayed in the same grid area.

Moreover, the number of grid areas in a workspace may vary based on implementation, the number of data objects in the workspace, user preference, and a number of other such factors. In other implementations, a workspace may contain more or less than nine grid areas.

### Sort Buckets

Sort buckets generally refer to those locations in a workspace where data objects collect when thrown by a user. For example, FIG. 1 shows four separate buckets for workspace 100. Basically, workspace 100 includes bucket 120 at the top of the workspace, bucket 121 at the right edge of the workspace, bucket 122 at the bottom of the workspace, and bucket 123 on the left edge of the workspace. In other implementations, the type and number of sort buckets in a workspace may differ. They may differ based on a variety of factors such as the type of data object, user preference, screen size, the number of data objects being sorted, etc. For example, a user managing music files on their computer may want to have a separate sort bucket for a each type of music they own (e.g., a bucket for “Classical”, “Hip-Hop”, “Jazz”, “Rock”, “Classic Rock”, “The Beatles”, “Reggae”, etc.).

In FIG. 1, buckets 120-123 are used to sort images displayed in a photo-editing tool. In this example, bucket 122 is a collection location in the workspace where the user throws his favorite images (e.g., his five-star images). Buckets 120 and 121 collects images that are not of the same quality as those in bucket 122 (e.g., the images in those buckets are one-star and three-star images). Workspace 100 may also include reject bucket 123. Here, reject bucket 123 acts like a trash can; it is a location in workspace 100 where the user throws images that the user does not wish to keep.

In one embodiment, a project environment comes with a set of pre-defined sort buckets which the user can use to sort data objects. Alternatively, the project environment allows the user to define a set of sort buckets. According to one embodiment, the sort buckets in a project environment can be a mix of user-defined and predefined buckets.

In one embodiment, sort buckets 120-123 are movable. This means that a user can “tear” a sort bucket from a screen location and move it to another location within the workspace. As used herein, tearing a sort bucket from a screen location means the user selects the sort bucket using his mouse or other input device and drags the sort bucket away from its current location. For example, suppose the user wants to place all of the sort buckets on the left side of workspace 100. In one embodiment, the user uses their mouse or other input device to drag and drop the sort bucket at a new location within a workspace (and even within the same project environment). In this way, the location of the sort buckets may be determined by the user.

In addition to collecting data objects, in one embodiment, sort buckets are selectable. A user can use his mouse to select a sort bucket, causing the content of the selected sort bucket to be displayed. According to one embodiment, the sort bucket's contents are displayed in their own separate workspace. For example, suppose a user throws ten data objects into sort bucket 122. The user may then want to sort those ten data objects. To do so, the user selects sort bucket 122, which causes the sort bucket to expand and become the focus. In one embodiment, after the sort bucket has been expanded the ten data objects in sort bucket 122 are displayed in greater detail to the user.

According to one embodiment, a sort bucket can have filters and property templates associated with it. As a result, filters and other properties in a project environment can be automatically applied to a data object when the data object is placed in a sort bucket. For example, in FIG. 1, a user may assign a red-eye reduction filter to sort bucket 122 so that every image thrown into sort bucket 122 is automatically filtered for red-eye. Similarly, the user may designate a 50% reduction in brightness for all images sent to the three-star sort bucket. Depending on implementation, other filters and properties may be assigned to sort buckets.

### Workflow

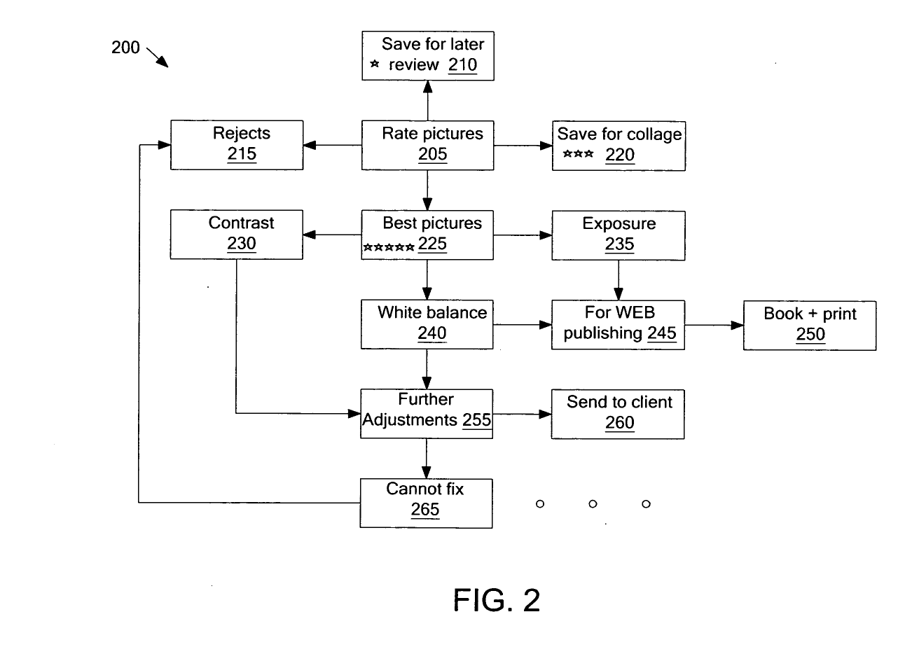

A workflow generally refers to the mechanism in a project environment that defines how workspaces are interrelated. Basically, a workflow describes a set of interconnected workspaces in a project environment. FIG. 2 illustrates an example workflow 200 that may be used in connection with an embodiment of the invention. In FIG. 2, a set of workspaces (205-265) are linked together to form workflow 200.

According to one embodiment, the linked workspaces correspond to sort buckets. For example, suppose a user sorts images in a photo-editing tool. In workflow 200, the images are initially displayed in the “rate pictures” workspace 205. The rate pictures workspace 205 includes the same sort buckets as those described in connection with workspace 100 in FIG. 1. Accordingly, the user sorts the images in workspace 205 by throwing them into the available sort buckets. The user then decides to further refine how the images are categorized. Hence, the user selects a sort bucket in the rate pictures workspace 205. By selecting a sort bucket, in one embodiment, a second workspace corresponding to the sort bucket. The newly opened workspace reveals the contents of the selected sort bucket. For instance, in rate pictures workspace 205, if the user throws several images into a five-star sort bucket, then when the user selects the five-star sort bucket new workspace 225 (e.g., the five-star workspace with its own set of sort buckets) opens in response to the selection.

The user can then sort the images in the five-star workspace 225 into sort buckets, select one of those sort buckets, and refine the collection of photos even further. This process can continue until the user has finished sorting all the images.

Workflow 200 illustrates how each workspace in a project environment is connected to other workspaces. As illustrated in FIG. 2, the rate pictures workspace 205 is linked to the five-star workspace 225, the one-star workspace 210, the rejects workspace 215, and three-star workspace 220. When the user navigates to a new workspace, the connected workspaces can change. For example, once the user has moved from the rate pictures workspace 205 to five-star workspace 225, the connected workspaces also change (e.g., five-star workspace is 225 connected to a contrast workspace 230, white balance workspace 240, and exposure workspace 235). Sort buckets representing each of these connected workspaces are displayed in the five-star workspace 225.

In the end, the user may continue sorting the images and selecting sort buckets until all the images have been sorted. In the end, the user may place images into the needs further adjustments workspace 255, those that cannot be fixed workspace 265, images that are meant for Web publishing or print workspaces 245 and 250, or into an images sent to client workspace 260.

### Defining the Workflow

In one embodiment, a workflow in a project environment can be created, edited, and modified by a user. In one embodiment, a workflow is predefined, e.g., provided by the project environment based on a set of predetermined preferences, including input from users. Alternatively, the photo-editing tool allows the user to modify or add workspaces to the workflow. For example, in FIG. 2, assume that workspaces 205, 210, 215, and 220 are part of a default workflow 200 provided by a photo-editing tool.

As the user begins to use the photo-editing tool, the user determines that he needs additional workspaces to categorize the images in a different way. According to one embodiment, the user can select an “add”, “edit”, or “delete” workspace control in the workspace user interface. The user then proceeds to add, edit, or delete workspaces in the workflow. Note that, in one embodiment, the user may create a workflow from scratch. Further note that the add, edit, or delete workspace feature can also be part of the photo-editing tool's user interface.

In one embodiment, when a user creates or adds a new sort bucket to a workspace, a corresponding workspace is created for the sort bucket.

### Workflow Indicator

Referring back to FIG. 1, in addition to the grid areas and the buckets, workspace 100 includes a workflow indicator 105. The workflow indicator 105 generally indicates the overall layout of the workflow in a project environment. As illustrated in FIG. 1, workflow indicator 105 includes several small rectangles that represent workspaces in the current workflow. In other implementations, the workflow indicator may use a different type of visual effect to represent workflow. For example, the workflow indicator could use words, circles, a grid, or some other mechanism to indicate workflow. In some cases, not every workspace is shown by the workflow indicator. This could be because of the number of connected workspace, the size of the workflow, user preference, etc.

The workflow indicator 105 highlights the current workspace. For example, in FIG. 1, workspace 100 happens to be the first workspace in the workflow. Therefore, it is highlighted. If the user wishes to switch to a different workspace in the workflow, in one embodiment, the user need only select one of the other rectangles in the workflow indicator.

### Throw a Data Object

In FIG. 1, after data objects have been imported and displayed in workspace 100, the user can sort the data objects by throwing them into sort buckets. Accordingly, the user sorts the displayed data objects by selecting a data object with their mouse and throwing it in the direction of a sort bucket.

To illustrate this process, assume the user has imported thousands of data objects into a project environment. Displaying that many objects can be difficult for the user to sift through. Thus, in one embodiment, the user elects to first sort through specific grid areas. So, the user selects grid area 110 to sort, which causes grid area 110 to become the focus of the workspace. FIG. 3 illustrates workspace 300, which is an example of what grid area 110 may look like after it has become the focus.

In one embodiment, workspace 300 represents a virtual light surface table where data objects are arranged for sorting. In this case, the data objects are images. At the top of workspace 300 is sort bucket 320 that is designed to hold photographs that the user classifies as one-star images. Workspace 300 also includes three-star sort bucket 321, five-star sort bucket 322, and reject bucket 323 similar to those defined in connection with FIG. 1. The displayed images can be actual photograph files or representations of those files (e.g., thumbnails). Workflow indicator 305 shows that the user has moved from the initial workspace 100 to a second workspace (e.g., the highlighted box indicates the user's new location in the workflow).

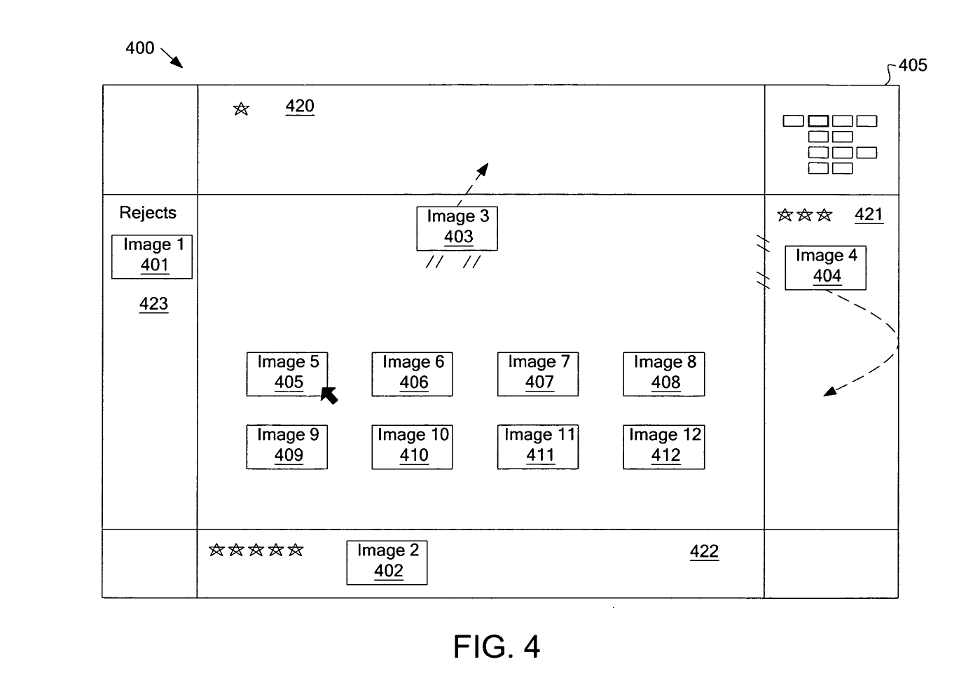

To continue the illustration of the process, the user begins sorting the images by throwing them into the sort buckets. For example, after importing a set of images into a photo-editing tool, one of the first things a photographer may do is sort through the images to find his four or five best shots. In FIG. 4, the photographer sorts through the images 401-412 by throwing them into sort buckets 420-423. As in FIG. 3, sort buckets 420-423 correspond to sort buckets 120-123 described in connection with FIG. 1. Using those sort buckets, the user can evaluate an image based on a particular quality, characteristic, or rating, and then throw the image into the sort bucket that corresponds to that particular quality, characteristic, or rating.

As shown in FIG. 4, the user can quickly sort through images 401-412. The user looks at an image, selects it with his mouse or other input device, determines where to throw the image (e.g., which sort bucket it should be sorted into), and throws the images in the direction of the sort bucket.

To illustrate, the user begins sorting the images shown in FIG. 4. The user looks at image_1 401, evaluates the image, and determines that the image is slightly out of focus and, therefore, unusable. The user then throws image_1 401 into rejects sort bucket 423. Throwing the image involves inputting a throw command. According to one embodiment, the throw command can be as simple as selecting an image with a mouse by clicking on it and flicking the mouse toward rejects sort bucket 423. The command could also be more involved, for example, the user may also have to release the mouse button while flicking the image in the direction of a sort bucket. The user input indicating a throw command can vary based on a wide variety of factors, such as the type of input device being used (e.g., joystick, pointer, keyboard, touchpad, or multi-touch pad), user preference, the type of application, etc. For example, a throw command from a keyboard may consist of a series of keystrokes. For example, the user selects an object and then enters “CTRL-T” followed by an “Up-Arrow” command. The CTRL-T indicates the command to throw the data object, and the Up-Arrow indicates the direction of the sort bucket.

The goal of throwing an object is to reduce the amount of movement a user must make when sorting data objects. In one embodiment, when a user uses a mouse to throw data objects, the user inputs only enough data (e.g., mouse movement) to indicate a throw command and a throw direction. For instances, the user clicks down on a data object and flicks the data object in the direction of the sort bucket (e.g., up, down, left, right, down to the left, down to right, etc.) There is very little waste of motion and movement. Thus, to sort the images shown in FIG. 4, the user picks a first image to begin the sorting process (e.g., image_1 401), throws the image at a sort bucket, and quickly picks another image to sort. In this way, a user can traverse a whole group of images using very few input device movements (especially when compared to conventional sorting techniques).

In one embodiment, the user may select more than one data object to throw for a given throw command. For example, in FIG. 4, the user selects multiple images in workspace 400 and throws them together towards the same bucket. When a user throws multiple objects, in one implementation, he first performs a unifying selection. A unifying selection occurs when all the data objects act temporarily as a single data object. Examples of making a unifying selection include selecting multiple images by CTRL-clicking on multiple data objects, performing a drag selection, or highlighting data objects in some other way.

In one embodiment, after a unifying selection is made, the unified data objects are shown in the workspace as a “stacked” object (e.g., the data objects are placed on top of each other). Then, in an embodiment, when the user throws the stacked object, upon landing at the desired location (e.g., a sort bucket), the stacked object separates into its respective data objects.

In addition, throwing a data object also involves animating the data object after the user inputs the throw command. For example, after the user has input a throw command, the thrown data object continues to move in the throw direction (e.g., the direction indicated by the throw command).

### Animate a Thrown Data Object

After a data object has been thrown, in one embodiment, the data object is animated. The way the data object is animated may vary based on a variety of criteria such as performance, aesthetics, ease of implementation, etc. In one embodiment, when a data object is thrown, it is animated in a way that mimics how real-life objects travel when they are thrown. For example, if a data object in a workspace is thrown “hard” (e.g., with more force, speed, or velocity), then the data object moves with greater velocity across the screen. Similarly, if a data object is thrown “softly” (e.g., with very little force, speed, or velocity), then the data object moves more slowly across the screen. In addition, as the object travels across the workspace, according to one embodiment, the data object decelerates (as if being acted upon by friction) until it stops. In other embodiments, the data object may move at the same speed until it reaches a sort bucket. In alternative embodiments, the data object stops after it has lost its momentum.

Consider the examples illustrated in FIG. 4. In FIG. 4, image_3 403 is an example of an image that was thrown by the user in the direction of sort bucket 420. In this case, the user gently throws image_3 403 in the direction of sort bucket 420. Image_3 403 moves across workspace 400 until it lands in sort bucket 420. In one embodiment, image_3 403 stops immediately upon reaching sort bucket 420. Alternatively, if image_3 403 has enough speed upon entering sort bucket 420, image_3 continues moving until it bounces against the other side of sort bucket 420. Image_4 404 is an example of a data object that was thrown hard enough that when it reaches sort bucket 421 it bounces off the outside edge of workspace 400 and eventually settles in the middle of the sort bucket.

### Catch the Data Object

A sort bucket catches thrown data objects. For example, in FIG. 4, suppose a user throws image_3 403 towards sort bucket 420. When image_3 403 reaches sort bucket 420, it is caught and remains in the sort bucket. In one embodiment, when a data object, such as image_4 404, is thrown into a sort bucket, the data object bounces back and forth off the edges of the sort bucket until it comes to a rest.

As additional objects are thrown into a sort bucket, in one embodiment, the data objects are displayed at the location where they end up as a result of being thrown. For example, suppose a user throws two or three data objects into the same sort bucket and those data objects end up overlapping each other. In one embodiment, the data objects are maintained in their overlapping and disorganized state. In this way, the project environment offers a workspace that imitates the real world. Alternatively, the data objects once caught into a sort bucket can be automatically rearranged in an ordered fashion.

### Sort Data Objects in a Sort Bucket

Once a user has sorted a collection of data objects into sort buckets, in one embodiment, the user may select a sort bucket to further narrow how the data objects are sorted. For example, suppose the user in FIG. 4 sorts each of the images 401-412 into one of the sort buckets 420-423. As result, four images are sorted into five-star sort bucket 422. The user then selects sort bucket 422. In one embodiment, by selecting sort bucket 422, the user moves to a new workspace in the workflow, where the user can further narrow how the images are sorted. In one embodiment, the move from one workspace to another is reflected in workflow indicator 405.

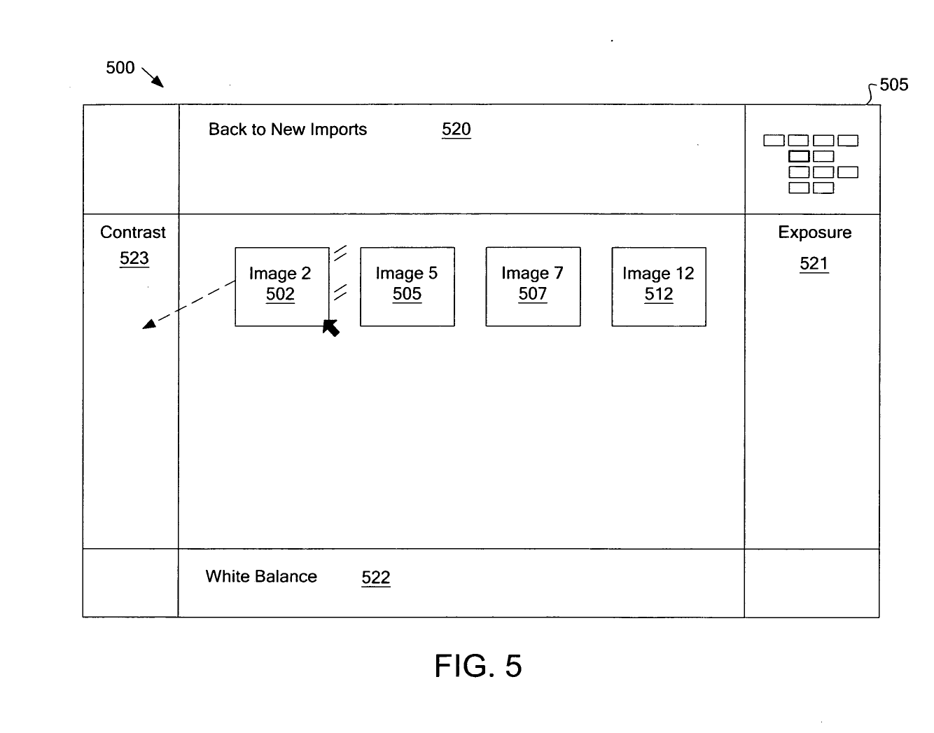

FIG. 5 illustrates an example of a workspace 500 that opens as a result of the user selecting sort bucket 422. Workflow indicator 505 also illustrates that the user has moved from one location in the workflow to another.

When the new workspace opens, in one embodiment, the images are rearranged into an ordered collection (e.g., into rows and columns). Similarly, in one embodiment, the data objects increase in display size since now fewer data objects are contained in each subsequent sort bucket. For instance, in workspace 500, since there are only four images displayed (as opposed to the twelve images displayed in workspace 400), the four images 502, 505, 507, and 512 are displayed as larger data objects.

Once the user is in workspace 500, the user may proceed to sort the data by throwing images 502, 505, 507, and 512 into sort buckets 520-523. For example, the user may throw image_2 502 into the “contrast” sort bucket 523, image_5 into the white balance sort bucket, etc.

### EXAMPLE PROCEDURE FOR THROWING DATA OBJECTS

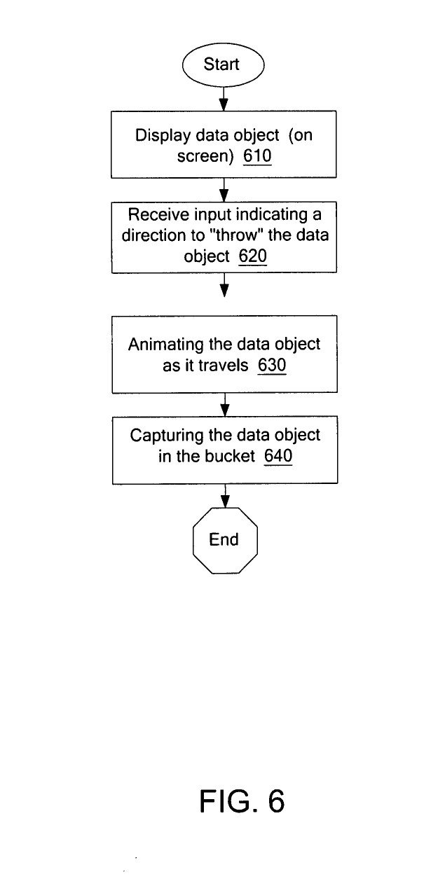

Turning to FIG. 6, it is a flowchart illustrating procedure 600 for sorting images in a user interface by allowing a user to select a data object and input a “throw” command that indicates where the user would like to send the data object. For example, in one embodiment, procedure 600 allows a user to sort images by throwing the images into sort buckets.

It should be noted that although, procedure 600 is discussed below in terms of a photographer sorting images using a photo-editing tool, the principles described in connection with procedure 600 can be applied to a wide variety of other scenarios such as sorting music files, moving documents from one folder to another, and other situations.

Assume for example that a photographer named John has just recently returned from a vacation to the Amazon jungle in Brazil. While in the jungle, John took a large number of pictures of the jungle wildlife and plants. Among the images are several shots of a very rare flower. He now plans to sort the pictures with the intent of finding a few quality shots of the flower to send to a nature magazine.

At step 610, John opens a photo-editing tool that displays images on screen. The photo-editing tool includes, among other things, a workspace user interface that allows the user to display images, sort the images, and edit and save the images. In addition, the photo-editing tool includes controls and the necessary underlying logic to create and/or edit sort buckets into which the photographer may wish to sort the images. According to one embodiment, the step of displaying the images may include importing the images into the photo-editing tool from a digital camera or other device.

In addition, displaying the images may also include displaying a compressed or compact representation of the image. For example, the images may be displayed as thumbnails or some other compressed version of the underlying images themselves. Although it should be noted that the content and format of the images opened in the photo-editing tool can vary from one project to the next and from one implementation to the next. For example, the photo-editing tool should be able to recognize multiple image file formats, such as JPG, GIF, TIF, RAW, BMP, etc.

Accordingly, John imports the pictures he took on his jungle trip into an initial workspace in the photo-editing tool. In one embodiment, the workspace in the photo-editing tool corresponds to workspace 100 illustrated in FIG. 1.

In the workspace, the images are displayed to John. However, the sheer number of images on display in the workspace makes it difficult for John to view and sift through the images (e.g., because they are small). In this example, the photo-editing tool includes grid areas that divide the workspace up into smaller collections of data. John selects grid area 110 in workspace 100. In one embodiment, grid area 110 and its images are expanded and become the focus of the tool, thus, making it easier for John to see and sort the images. Alternatively, a completely new workspace that includes all of the images from grid area 110 is opened when John selects grid area 110. In one embodiment, this subsequent workspace corresponds to workspace 300 in FIG. 3.

In FIG. 6 at step 620, John begins to sort the images displayed in the current workspace. To do so, he evaluates the images on display and throws them towards sort buckets located somewhere on screen. The throwing motion in this case involves receiving input indicating a “throw” command (e.g., selecting an image in the current workspace and using his mouse to throw it in the direction of a sort bucket). For example, John uses his mouse or other input device to click on an image in the workspace (thereby selecting it) and flicking the mouse toward a sort bucket, while simultaneously releasing the mouse button. And the image glides to the sort bucket. Obviously, other tools, input devices, or input commands may be used to indicate a throw command.

It should be noted that John does not necessarily need to sort the images in the workspace in any particular order. He could select any photo at any location in the workspace to throw into a sort bucket. For example, he may want to first get rid of any blank or darkened images. Thus, he starts the sorting process by selecting the blank and darkened images to throw into a rejects sort bucket. John uses his mouse or other input device to select the images and throw them into a sort bucket. As he continues to sort the images, he works his way from the middle of the workspace out. Although, in some implementations, the sort buckets may be placed in a different location, so he may end up moving from right to left, left to right, middle to out, up down, down up, etc. FIG. 4 illustrates an example way of sorting through the displayed images.

Note that the sort buckets themselves, according to one embodiment, may be defined by John. In designing his workflow, John may define the number, type, and names of the sort buckets that are used during the sorting process. For example, referring to FIG. 4, John could define a one-star bucket 420, three-star bucket 421, etc. In addition, he may create and label other workspaces. He may even create and label a sort bucket called “Flower” since his first task for the day is to find those rare flower pictures among thousands of images.

At step 630, images are animated when thrown to a different location on screen. According to one embodiment, FIG. 4 illustrates example images being thrown into sort buckets. For instance, suppose John wants to sort the images in workspace 400 into sort buckets 420-423. To do so, he looks at an image, evaluates it, and throws the image into the sort bucket that best represents his perception of it. As an example, John looks at image_1 401 and notices that the image is blank, so he throws image_1 401 into the rejects sort bucket 423. John then looks at image_2 402 and decides that this image looks amazing. It is a picture of a flower that he would definitely consider sending to the nature magazine. Hence, image_2 402 is thrown into the five-star sort bucket 422. Continuing, John looks at image_3 403 and decides that image_3 is an okay image, but one that probably needs a lot of work to make it usable. Thus, he throws it into the one-star sort bucket 420. Notice that throwing images to the sort buckets requires very little wasted motion on John's part. John looks at an image, clicks on it, and throws it out of the way. In other words, John does not have to move an image from one side of the workspace to the other (e.g., dragging it all of the way over to the other side of the workspace). He simply flicks his mouse in the direction of a sort bucket and the image flies (or floats, depending on how hard he throws the image) in the direction of the designated sort bucket. As an additional benefit, since the throwing motion requires so little motion, John does not need to take his eyes off of the center portion of the workspace. This helps speed up the sorting process.

In one embodiment, once an image is thrown, just like friction on a table, the image slows down over time. Moreover, the speed and distance which the image travels in the workspace can be based on how hard it is thrown. For example, when John selects image_1 he may softly flick his mouse in the direction of the reject sort bucket 423. In this case, image_1 401 may travel slowly toward the sort bucket. John may then throw image_2 402 hard to make it travel faster to the five-star bucket. In one embodiment, the photo-editing tool includes controls that allow the user to select and modify how an image moves after it is thrown (e.g., how fast it moves, how much friction effects the image, whether to show the image flying across the workspace, or just placing the image in the sort bucket that is in the direction indicated by the user).

At step 640, when an image reaches a sort bucket the image is caught and stopped. In one embodiment, when an image reaches a sort bucket it immediately comes to rest. Alternatively, the image bounces against the walls of the sort bucket until it comes to an eventual stop. For example, suppose John throws image_4 404 hard toward sort bucket 421. Image_4 404 is caught in the sort bucket 421 but continues moving until it bounces against the sort bucket's far edge. It might then bounce back and collide with the sort bucket's other wall, and continue bouncing until it has lost momentum, coming to a rest somewhere in the middle of the sort bucket.

In this way, a sort bucket can act like a one way valve, once an image has entered the sort bucket, it cannot get out. Images that bounce and glide into an area feel more realistic and can be more aesthetically pleasing to the user. Moreover, in one embodiment, where an image stops in a sort bucket is irrelevant. For example, John might continue throwing additional images into the five-star bucket so that the images overlap. In one embodiment, workspace 400 provides John with a control to reorder the images in an organized way. Alternatively, if the images are disorganized after being thrown into a sort bucket, those images are reordered when John selects the sort bucket. In other words, once John selects a sort bucket with images in it, the images are reordered and realigned in the display.

For example, after sorting the images in workspace 400, John decides he would like to further sort the images in the five-star bucket. He selects bucket 422. In one embodiment, a new workspace corresponding to workspace 500 in FIG. 5 is opened. The images in the sort bucket are reordered and realigned in a row in the new workspace. In addition, the images are enlarged (e.g., because there are fewer of them in the workspace). John can then sort the five-star images into additional sort buckets. Here, the sort buckets represent specific image properties and characteristics that may need to be modified. For example, as John looks in greater detail at image_2 502, he decides it needs to have the contrast modified slightly to make the flower pictured in the image stand out more. Accordingly, he throws the image into the contrast sort bucket 523. In one embodiment, sort bucket 523 acts as a holding place for the image until John has time to come back and edit it later.

Alternatively, before throwing images into a bucket John may assign some predetermined adjustments or filters to a sort bucket so that when an image is thrown into a sort bucket that particular filter or property adjustment is automatically applied. For example, John may have set a filter on sort bucket 523 so that images thrown into it automatically have their contrast adjusted by 10%.

According to one embodiment, John could also set a filter by first editing an image and then saving those edits as a property template or filter to be applied to subsequent images. For example, John throws image_2 502 into sort bucket 523, modifies the image at that time, and then saves the modifications to the image as a template. Subsequent images thrown in sort bucket 523 then have that same filter or applied.

After throwing image_2 502 into sort bucket 523, John can continue sorting the other images. As always, the sort buckets for a workspace can vary from one implementation to the next. In FIG. 5, there is a contrast sort bucket 523, an exposure sort bucket 521, a white balance sort bucket 522, and a back to sort pictures bucket 520 (“back bucket”).

John throws image_5 505 into the exposure sort bucket 521 and image_7 into the white balance sort bucket 522. The back bucket 520 connects to the previous workspace (e.g., workspace 410) and allows John to throw images back to the original workspace. For example, after John gets a closer look at image_12 512, he decides he was mistaken: image_12 512 is not a five-star image. However, he still likes the image and would like to keep it. Accordingly, he throws it into the back bucket. The image is placed back in the previous workspace.

To move back to the previous (or other workspace), John can select the back bucket 520 or alternatively a different workspace from the workflow indicator 505.

Once all the images have been sorted, John can save the project and come back to it later. He can modify the images, save them, export them, get them ready to send to the nature magazine, etc. In one embodiment, John can save the entire group of images as a single project. Alternatively, each collection of images in a workspace is saved as its own collection. According to one embodiment, John can save images individually.

### Hardware Overview

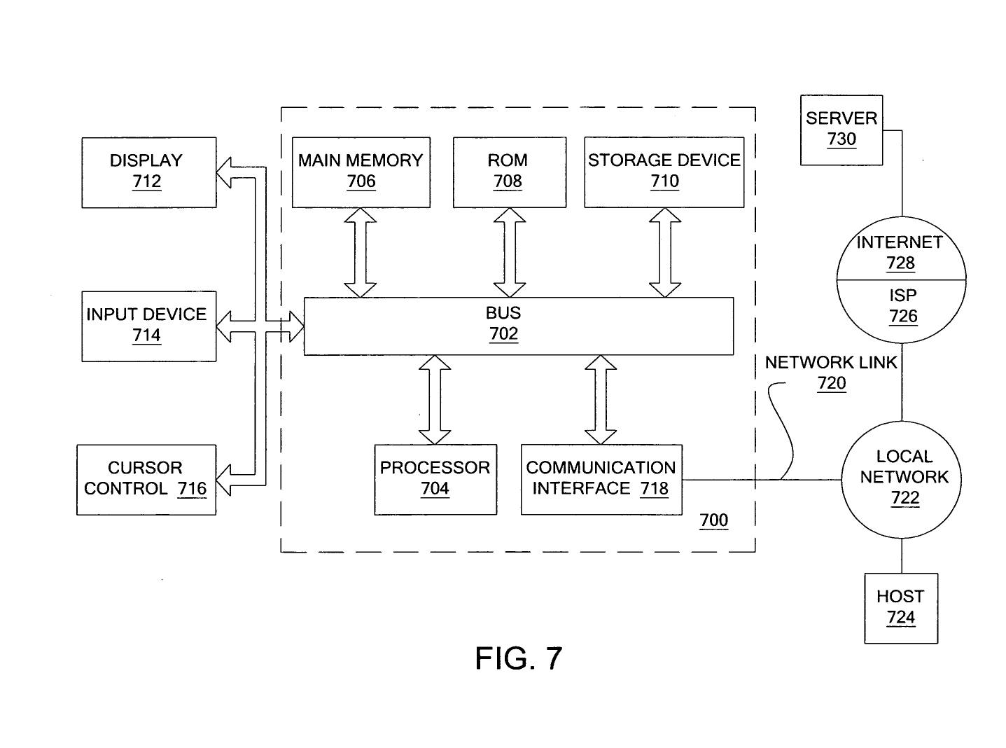

FIG. 7 is a block diagram that illustrates a computer system 700 upon which an embodiment of the invention may be implemented. Computer system 700 includes a bus 702 or other communication mechanism for communicating information, and a processor 704 coupled with bus 702 for processing information. Computer system 700 also includes a main memory 706, such as a random access memory (RAM) or other dynamic storage device, coupled to bus 702 for storing information and instructions to be executed by processor 704. Main memory 706 also may be used for storing temporary variables or other intermediate information during execution of instructions to be executed by processor 704. Computer system 700 further includes a read only memory (ROM) 708 or other static storage device coupled to bus 702 for storing static information and instructions for processor 704. A storage device 710, such as a magnetic disk or optical disk, is provided and coupled to bus 702 for storing information and instructions.

Computer system 700 may be coupled via bus 702 to a display 712, such as a cathode ray tube (CRT), for displaying information to a computer user. An input device 714, including alphanumeric and other keys, is coupled to bus 702 for communicating information and command selections to processor 704. Another type of user input device is cursor control 716, such as a mouse, a trackball, or cursor direction keys for communicating direction information and command selections to processor 704 and for controlling cursor movement on display 712. This input device typically has two degrees of freedom in two axes, a first axis (e.g., x) and a second axis (e.g., y), that allows the device to specify positions in a plane.

The invention is related to the use of computer system 700 for implementing the techniques described herein. According to one implementation of the invention, those techniques are performed by computer system 700 in response to processor 704 executing one or more sequences of one or more instructions contained in main memory 706. Such instructions may be read into main memory 706 from another machine-readable medium, such as storage device 710. Execution of the sequences of instructions contained in main memory 706 causes processor 704 to perform the process steps described herein. In alternative implementations, hard-wired circuitry may be used in place of or in combination with software instructions to implement the invention. Thus, implementations of the invention are not limited to any specific combination of hardware circuitry and software.

The term “machine-readable medium” as used herein refers to any medium that participates in providing data that causes a machine to operation in a specific fashion. In an implementation implemented using computer system 700, various machine-readable media are involved, for example, in providing instructions to processor 704 for execution. Such a medium may take many forms, including but not limited to, non-volatile media, volatile media, and transmission media. Non-volatile media includes, for example, optical or magnetic disks, such as storage device 710. Volatile media includes dynamic memory, such as main memory 706. Transmission media includes coaxial cables, copper wire and fiber optics, including the wires that comprise bus 702. Transmission media can also take the form of acoustic or light waves, such as those generated during radio-wave and infra-red data communications. All such media must be tangible to enable the instructions carried by the media to be detected by a physical mechanism that reads the instructions into a machine.

Common forms of machine-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, and EPROM, a FLASH-EPROM, any other memory chip or cartridge, a carrier wave as described hereinafter, or any other medium from which a computer can read.

Various forms of machine-readable media may be involved in carrying one or more sequences of one or more instructions to processor 704 for execution. For example, the instructions may initially be carried on a magnetic disk of a remote computer. The remote computer can load the instructions into its dynamic memory and send the instructions over a telephone line using a modem. A modem local to computer system 700 can receive the data on the telephone line and use an infra-red transmitter to convert the data to an infra-red signal. An infra-red detector can receive the data carried in the infra-red signal and appropriate circuitry can place the data on bus 702. Bus 702 carries the data to main memory 706, from which processor 704 retrieves and executes the instructions. The instructions received by main memory 706 may optionally be stored on storage device 710 either before or after execution by processor 704.

Computer system 700 also includes a communication interface 718 coupled to bus 702. Communication interface 718 provides a two-way data communication coupling to a network link 720 that is connected to a local network 722. For example, communication interface 718 may be an integrated services digital network (ISDN) card or a modem to provide a data communication connection to a corresponding type of telephone line. As another example, communication interface 718 may be a local area network (LAN) card to provide a data communication connection to a compatible LAN. Wireless links may also be implemented. In any such implementation, communication interface 718 sends and receives electrical, electromagnetic or optical signals that carry digital data streams representing various types of information.

Network link 720 typically provides data communication through one or more networks to other data devices. For example, network link 720 may provide a connection through local network 722 to a host computer 724 or to data equipment operated by an Internet Service Provider (ISP) 726. ISP 726 in turn provides data communication services through the world wide packet data communication network now commonly referred to as the “Internet” 728. Local network 722 and Internet 728 both use electrical, electromagnetic or optical signals that carry digital data streams. The signals through the various networks and the signals on network link 720 and through communication interface 718, which carry the digital data to and from computer system 700, are exemplary forms of carrier waves transporting the information.

Computer system 700 can send messages and receive data, including program code, through the network(s), network link 720 and communication interface 718. In the Internet example, a server 730 might transmit a requested code for an application program through Internet 728, ISP 726, local network 722 and communication interface 718.

The received code may be executed by processor 704 as it is received, and/or stored in storage device 710, or other non-volatile storage for later execution. In this manner, computer system 700 may obtain application code in the form of a carrier wave.

In the foregoing specification, implementations of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

1. A method for sorting data objects on a screen, the method comprising:
displaying a set of data objects in a user interface on the screen;
receiving user input in connection with at least one of said data objects in the set of data objects;
wherein said user input indicates (a) a direction, in the user interface, to move said at least one data object and (b) an initial velocity to move said at least one data object in said direction; and
in response to the user input, moving the at least one data object across the user interface based on said direction and said initial velocity,
wherein moving the at least one data object across the user interface includes continuing to move the at least one data object for some period of time after receipt of the user input.

2. The method of claim 1, wherein moving the at least one data object across the user interface based on said direction and said initial velocity includes moving the at least one data object into a confined area on the screen.

3. The method of claim 2, wherein moving the at least one data object into a confined area on the screen includes displaying the at least one data object moving in the confined area.

4. The method of claim 3, wherein said moving in the confined area includes bouncing off an edge of the confined area.

5. The method of claim 3, wherein displaying the at least one data object in the confined area includes decelerating the at least one data object over the period of time.

6. The method of claim 2, wherein the confined area includes user interface controls to move the confined area from one location in the user interface to a different location in the user interface.

7. The method of claim 1, wherein the user interface is divided into a set of grid areas, wherein each grid area in the set of grid areas includes a subset of the set of data objects and wherein each grid area in the set of grid areas is selectable through user input.

8. The method of claim 7, further comprising:
receiving user input to select a grid area in the set of grid areas; and
expanding said grid area in the user interface, wherein expanding the grid area causes said grid area to become a focus of the user interface.

9. The method of claim 8, wherein expanding said grid area in the user interface includes enlarging a display size for each data object displayed in the subset of data objects.

10. The method of claim 1, wherein the user input further comprises selecting a data object with a mouse and moving the mouse while the data object is selected.

11. The method of claim 1, wherein moving the at least one data object in the direction indicated by the user input includes displaying the at least one data object at one or more intermediate locations on said user interface before displaying said at least one data object at a final location on said user interface.

12. The method of claim 11, wherein displaying the at least one data object at one or more intermediate locations includes:
analyzing the user input to determine the initial velocity of the at least one data; and
moving the at least one data object based on the initial velocity of the at least one data object.

13. The method of claim 1, wherein continuing to move the at least one data object for some period of time after receipt of the user input includes moving the object at the initial velocity over the period of time.

14. The method of claim 1, wherein continuing to move the at least one data object for some period of time after receipt of the user input includes decelerating the object over the period of time.

15. The method of claim 2, wherein the confined area corresponds to a workspace in the user interface.

16. The method of claim 15, further comprising receiving user input to define a new confined area in the user interface.

17. The method of claim 2, wherein moving the at least one data object into a confined area on the screen includes applying a filter to the at least one data object, wherein said filter causes a property of said at least one data object to be modified when said at least one data object is moved into said confined area.

18. A machine-readable medium carrying instructions for sorting data objects on a screen, wherein execution of the instructions by one or more processors causes:
displaying a set of data objects in a user interface on the screen;
receiving user input in connection with at least one of said data objects in the set of data objects;
wherein said user input indicates (a) a direction, in the user interface, to move said at least one data object and (b) an initial velocity to move said at least one data object in said direction; and
in response to the user input, moving the at least one data object across the user interface based on said direction and said initial velocity,
wherein moving the at least one data object across the user interface includes continuing to move the at least one data object for some period of time after receipt of the user input.

19. The machine-readable medium of claim 18, wherein moving the at least one data object across the user interface based on said direction and said initial velocity includes moving the at least one data object into a confined area on the screen.

20. The machine-readable medium of claim 19, wherein moving the at least one data object into a confined area on the screen includes displaying the at least one data object moving in the confined area.

21. The machine-readable medium of claim 20, wherein said moving in the confined area includes bouncing off an edge of the confined area.

22. The machine-readable medium of claim 20, wherein displaying the at least one data object in the confined area includes decelerating the at least one data object over the period of time.

23. The machine-readable medium of claim 19, wherein the confined area includes user interface controls to move the confined area from one location in the user interface to a different location in the user interface.

24. The machine-readable medium of claim 18, wherein the user interface is divided into a set of grid areas, wherein each grid area in the set of grid areas includes a subset of the set of data objects and wherein each grid area in the set of grid areas is selectable through user input.

25. The machine-readable medium of claim 24, further comprising instructions for:
receiving user input to select a grid area in the set of grid areas; and
expanding said grid area in the user interface, wherein expanding the grid area causes said grid area to become a focus of the user interface.

26. The machine-readable medium of claim 25, wherein expanding said grid area in the user interface includes enlarging a display size for each data object displayed in the subset of data objects.

27. The machine-readable medium of claim 18, wherein the user input further comprises selecting a data object with a mouse and moving the mouse while the data object is selected.

28. The machine-readable medium of claim 18, wherein moving the at least one data object in the direction indicated by the user input includes displaying the at least one data object at one or more intermediate locations on said user interface before displaying said at least one data object at a final location on said user interface.

29. The machine-readable medium of claim 28, wherein displaying the at least one data object at one or more intermediate locations includes:
analyzing the user input to determine the initial velocity of the at least one data; and
moving the at least one data object based on the initial velocity of the at least one data object.

30. The machine-readable medium of claim 18, wherein continuing to move the at least one data object for some period of time after receipt of the user input includes moving the object at the initial velocity over the period of time.

31. The machine-readable medium of claim 18, wherein continuing to move the at least one data object for some period of time after receipt of the user input includes decelerating the object over the period of time.

32. The machine-readable medium of claim 19, wherein the confined area corresponds to a workspace in the user interface.

33. The machine-readable medium of claim 32, further comprising instructions for receiving user input to define a new confined area in the user interface.

34. The machine-readable medium of claim 19, wherein moving the at least one data object into a confined area on the screen includes applying a filter to the at least one data object, wherein said filter causes a property of said at least one data object to be modified when said at least one data object is moved into said confined area.

35. An apparatus for sorting data objects on a screen, comprising:
one or more processors; and
a machine-readable medium carrying instructions, wherein execution of the instructions by the one or more processors causes:
displaying a set of data objects in a user interface on the screen;
receiving user input in connection with at least one of said data objects in the set of data objects;
wherein said user input indicates (a) a direction, in the user interface, to move said at least one data object and (b) an initial velocity to move said at least one data object in said direction; and
in response to the user input, moving the at least one data object across the user interface based on said direction and said initial velocity,
wherein moving the at least one data object across the user interface includes continuing to move the at least one data object for some period of time after receipt of the user input.

36. The apparatus of claim 35, wherein moving the at least one data object across the user interface based on said direction and said initial velocity includes moving the at least one data object into a confined area on the screen.

37. The apparatus of claim 36, wherein moving the at least one data object into a confined area on the screen includes displaying the at least one data object moving in the confined area.

38. The apparatus of claim 37, wherein said moving in the confined area includes bouncing off an edge of the confined area.

39. The apparatus of claim 37, wherein displaying the at least one data object in the confined area includes decelerating the at least one data object over the period of time.

40. The apparatus of claim 36, wherein the confined area includes user interface controls to move the confined area from one location in the user interface to a different location in the user interface.

41. The apparatus of claim 35, wherein the user interface is divided into a set of grid areas, wherein each grid area in the set of grid areas includes a subset of the set of data objects and wherein each grid area in the set of grid areas is selectable through user input.

42. The apparatus of claim 41, further comprising instructions for:
receiving user input to select a grid area in the set of grid areas; and
expanding said grid area in the user interface, wherein expanding the grid area causes said grid area to become a focus of the user interface.

43. The apparatus of claim 42, wherein expanding said grid area in the user interface includes enlarging a display size for each data object displayed in the subset of data objects.

44. The apparatus of claim 35, wherein the user input further comprises selecting a data object with a mouse and moving the mouse while the data object is selected.

45. The apparatus of claim 35, wherein moving the at least one data object in the direction indicated by the user input includes displaying the at least one data object at one or more intermediate locations on said user interface before displaying said at least one data object at a final location on said user interface.

46. The apparatus of claim 45, wherein displaying the at least one data object at one or more intermediate locations includes:
analyzing the user input to determine the initial velocity of the at least one data; and
moving the at least one data object based on the initial velocity of the at least one data object.

47. The apparatus of claim 35, wherein continuing to move the at least one data object for some period of time after receipt of the user input includes moving the object at the initial velocity over the period of time.

48. The apparatus of claim 35, wherein continuing to move the at least one data object for some period of time after receipt of the user input includes decelerating the object over the period of time.

49. The apparatus of claim 36, wherein the confined area corresponds to a workspace in the user interface.

50. The apparatus of claim 49, further comprising instructions for receiving user input to define a new confined area in the user interface.

51. The apparatus of claim 36, wherein moving the at least one data object into a confined area on the screen includes applying a filter to the at least one data object, wherein said filter causes a property of said at least one data object to be modified when said at least one data object is moved into said confined area.

52. A method for sorting data objects on a screen, the method comprising:
displaying a set of data objects in a user interface on the screen;
receiving user input in connection with at least one of said data objects in the set of data objects;
wherein said user input indicates a direction, in the user interface, to throw said at least one data object;
in response to the user input, moving the at least one data object across the user interface based on said direction,
wherein moving the at least one data object across the user interface includes continuing to move the at least one data object for some period of time after receipt of the user input.

53. The method of claim 52, wherein moving the at least one data object across the user interface based on said direction includes moving the at least one data object into a confined area on the screen.
